(19) United States
(12) Patent Application Publication
(10) Pub. No.: US 2016/0230977 A1
(43) Pub. Date: Aug. 11, 2016

(54) LED COOLING DEVICE

(71) Applicant: KIM Hwa Ja, Ansan-si Gyeonggi-do (KR)

(72) Inventors: Hwa Ja KIM, Ansan (KR); Soon Dong KANG, Gunpo (KR); Seong Ho CHOI, Gwangmyeong (KR)

(21) Appl. No.: 15/028,443

(22) PCT Filed: Oct. 6, 2014
(86) PCT No.: PCT/KR2014/009387

§ 371 Date: Apr. 11, 2016

(30) Foreign Application Priority Data
Oct. 11, 2013 (KR) 10-2013-0120966

(51) Int. Cl. F21V 29/60; F21V 29/70

(52) U.S. Cl. CPC F21V 29/60; F21V 29/70; F21Y 2101/02

(57) ABSTRACT

The present invention relates to an LED cooling device and, more specifically, to an LED cooling device for increasing cooling efficiency by smoothly circulating air in an LED module, comprising a structure having: an LED lamp in which LEDs for emitting light are provided on one lateral surface of a substrate and a heat exchange means for absorbing and radiating heat is provided on the other lateral surface of the substrate; a pumping member in which a supply hole for supplying air is formed at a lower end on the outer circumference of one side on one lateral surface of the heat exchange means of the LED lamp and an inflow hole for introducing the air is formed at a central part of an upper end thereof, wherein a check valve for controlling the inflow of air is provided at the inflow hole; an operating lobe which has a predetermined length and is provided at a central part of a lower end of the pumping member; and a transfer unit for upwardly and downwardly moving the operating lobe to expand or contract the pumping member.

### TECHNICAL FIELD

The present invention relates to an LED cooling device, and more specifically, to an LED cooling device that increases cooling efficiency by smoothly circulating air to an LED module.

### BACKGROUND ART

As an indoor lighting source in home or an office, a discharge lamp such as a fluorescent lamp, an incandescent lamp, a halogen lamp has been currently used.

There are problems that energy consumption is large due to the boosting of power since such a discharge lamp has a high driving voltage and discharge gas causes environmental pollution and is hardly recycled since a discharge gas such as mercury harmful to a human body or environment at the time of disposal is discharged.

Particularly, in the European Union (EU), the Restrictions on the use of Hazardous Substances (RoHS) that prohibits the use of heavy metal such as lead, mercury, cadmium or hexavalent chrome (Cr6+) and a toxic substance such as PBB (PolyBromideBinpenyl).PBDE (PolyBrominated Diphenyl Ether) in electrical and electronic products and the Waste Electrical and Electronic Equipment Directive (WEEE) that causes manufactures to pay fee for the recycling of waste electrical and electronic products have been legislated and have been enforced since Jul. 1, 2006.

Accordingly, an LED lighting device capable of being replaced with the currently used lighting device such as the incandescent lamp or the fluorescent lamp has been highly favored.

Such an LED has advantages such as high lighting speed and low power consumption, but has a problem that since the LED lighting device includes a plurality of LED elements, the amount of generated heat is large. Accordingly, in order to radiate the heat emitted from the LED elements, as shown in FIG. 1, the LED lighting device includes an LED lighting unit 200 that includes a PCB board, and a plurality of LED elements mounted on the PCB board; thermal conduction means that includes at least one thermal conduction plate 250 which transfers the heat by coming contact with or adhering to a surface of the PCB board opposite to the surface on which the LED elements are mounted; an operational-lobe heat supporting member 300 that includes a connection support 320 which is supported by being coupled to the LED lighting unit 200 and is connected to the thermal conduction plate 250, and a supporting body 310 provided with a body having a predetermined size such that the heat transferred from the thermal conduction plate 250 is stored by an operational lobe; and heat exchanging means that is connected to the operational-lobe heat supporting member 300 to receive the heat stored in the operational-lobe heat supporting member 300 by the operational lobe and enables heat exchange with external air to radiate the heat.

Since several LEDs are mounted on the PCB board of the LED, the amount of generated heat is large, and thus, the heat generated inside the LED lighting device due to the use for a predetermined period of time is not smoothly discharged through the heat exchanging means. As a result, efficiency is degraded, and thus, there is a problem that the lifespan of the LED lighting device is shortened when the LED lighting device is continuously used for a long period of time.

### CITATION LIST

### Patent Literature

Patent Literature 1: Korean Patent Registration No. 0948955

### DISCLOSURE

### Technical Problem

In order to solve such problems in the related art, an object of the present invention is to provide an LED cooling device capable of increasing cooling efficiency by smoothly circulating air to heat exchanging means provided on a rear surface of an LED.

### Technical Solution

In order to achieve the above object, the present invention provides an LED lamp which an LED which emits light is provided on one surface of a substrate and heat exchanging means which absorbs heat and radiates the absorbed heat on the other surface; a pumping member that includes a supply hole which is formed at a lower end of an outer periphery on one surface to supply air to one surface of the heat exchanging means of the LED lamp, an introduction hole which is formed at the center of an upper end in order to allow air to be introduced, and a check valve which is formed at the introduction hole to control the introduction of the air; an operational lobe that is provided at the center of a lower end of the pumping member at a predetermined length; and a transfer unit that moves the operation lobe up and down to expand and contract the pumping member.

A corrugated pipe may be formed at a center of a lower end of the pumping member with a predetermined length, and the operational lobe may be connected to one surface of the corrugated pipe.

A second supply hole connected to the pumping member may be formed in the operational lobe.

Pumping members may be provided at both ends of the operational lobe.

### Effect of the Invention

According to the LED cooling device of the present invention, the cooling device that supplies the air to the heat exchanging means that absorbs the heat of the LED and radiates the heat is provided, and thus, the air is smoothly circulated to the heat exchanging means that absorbs the heat and the radiates the heat. Accordingly, it is possible to increase the cooling efficiency.

### DESCRIPTION OF DRAWINGS

FIG. 1 is a cut-off perspective view showing an LED of the related art.

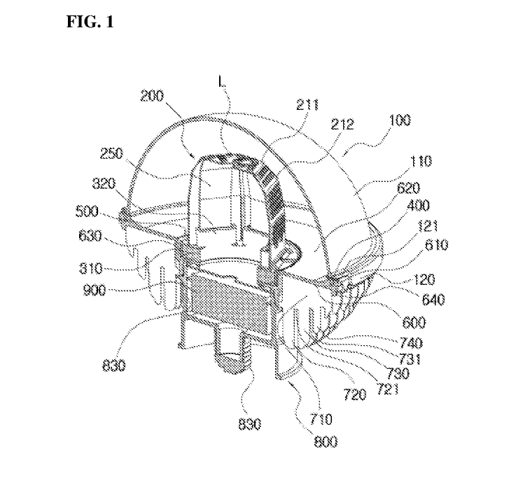

FIG. 2 is a cut-off perspective view showing an LED cooling device of the present invention.

FIG. 3 is a sectional view showing the LED cooling device of the present invention.

FIG. 4A is a cut-off perspective view showing a check valve of the present invention.

FIG. 4B is an enlarged view of portion “A” in FIG. 3.

FIGS. 5A and 5B show operation examples of the check valve of the present invention.

FIG. 6 shows another embodiment of the LED cooling device of the present invention.

FIG. 7 shows still another embodiment of the LED cooling device of the present invention.

FIGS. 8A and 8B show usage examples of the LED cooling device of the present invention.

### BEST MODE

Hereinafter, preferred embodiments of the present invention will be described in detail with reference to the accompanying drawings. Before the description, terms and words used in the present specification and claims are not interpreted as the meaning generally used in the dictionary, but should be interpreted as the meaning and concept coincident with the technological sprit of the present invention on the basis of a fundamental rule that an inventor can suitably define the concept of corresponding terms to describe his or her invention using the best method.

Accordingly, embodiments described in the specification and configurations illustrated in the drawings are merely preferred embodiments of the present invention, and do not wholly represent the technical sprit of the present invention. Therefore, it should be appreciated that various modifications and equivalents to these embodiments are possible at the time of filing the present application.

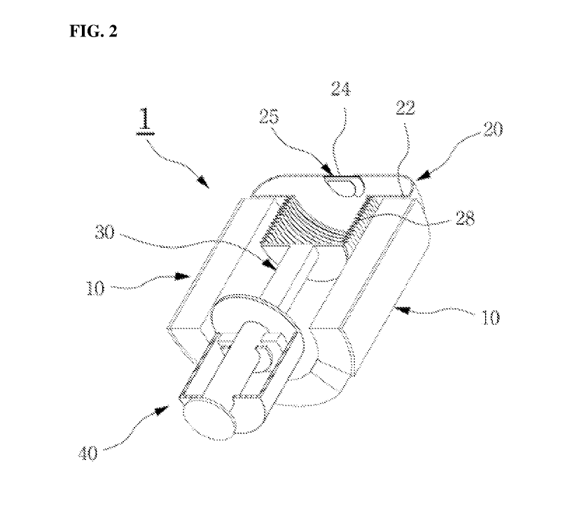

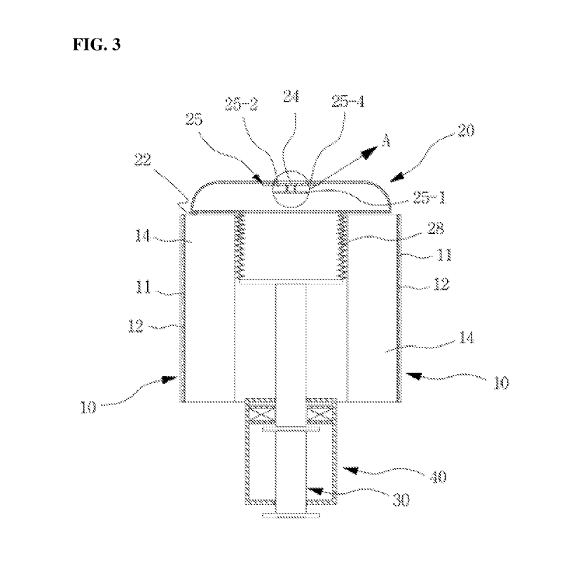

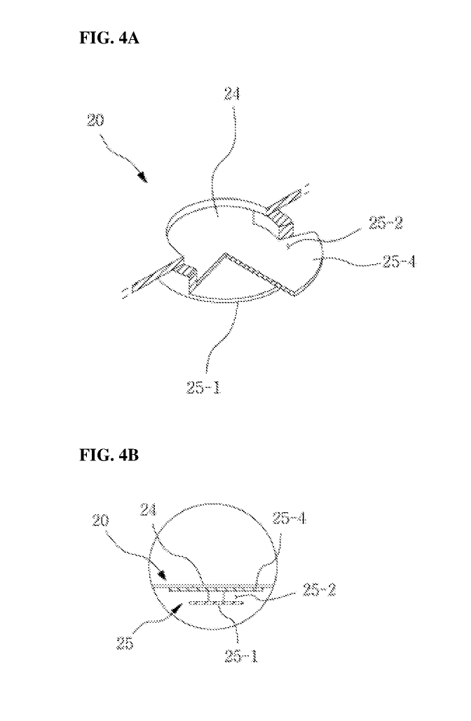

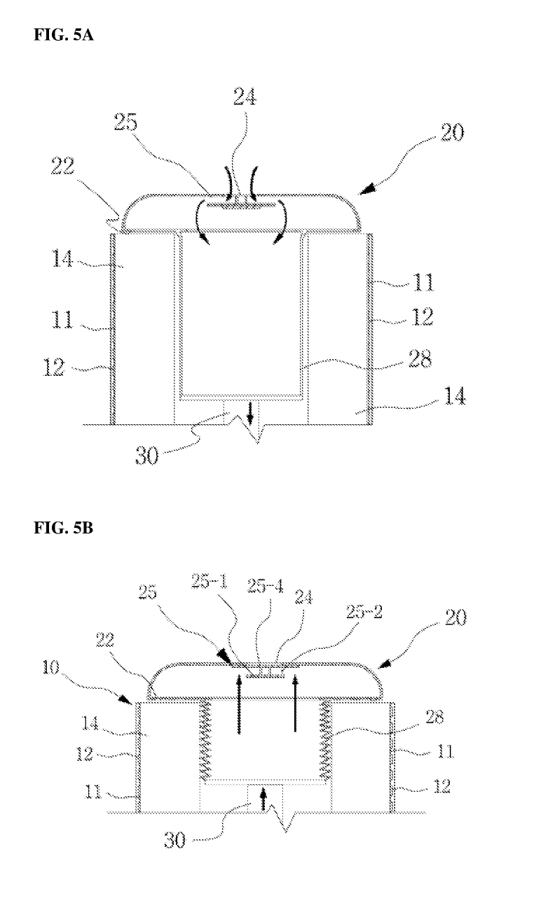

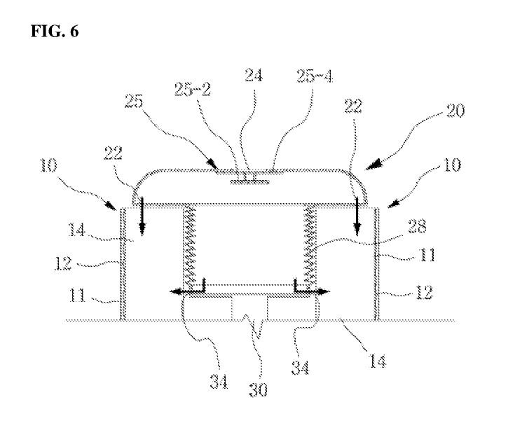

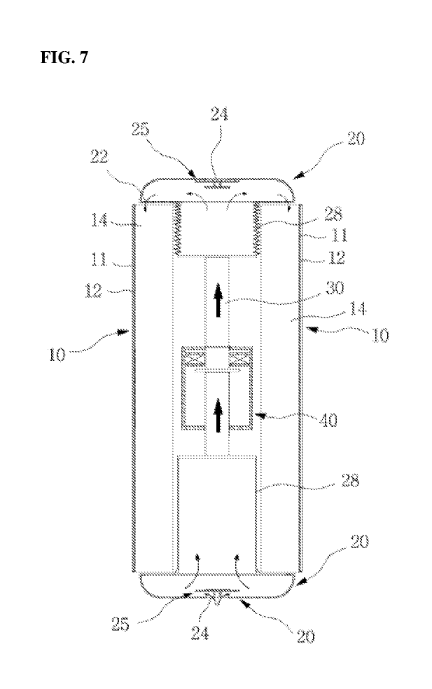

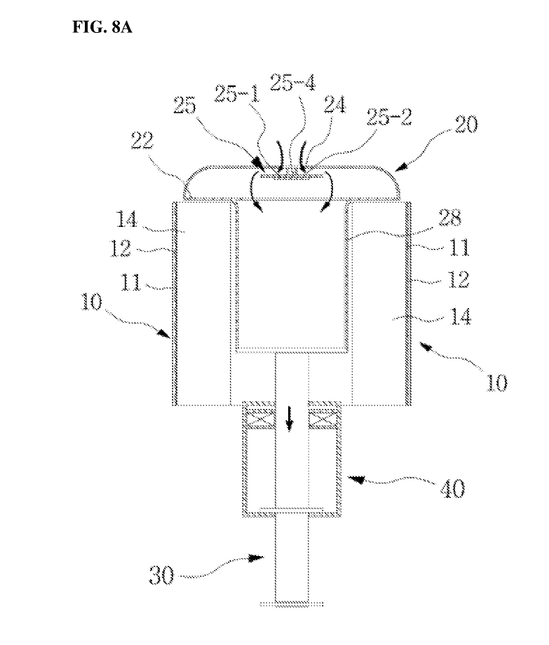

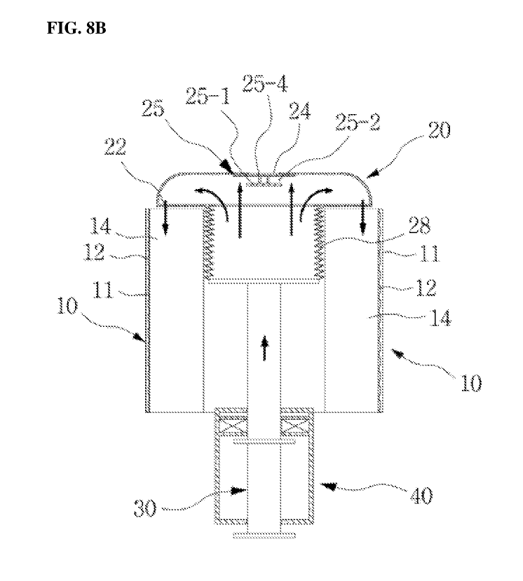

FIG. 2 is a cut-off perspective view showing an LED cooling device of the present invention, FIG. 3 is a sectional view showing the LED cooling device of the present invention, FIG. 4A is a cut-off perspective view showing a check valve of the present invention, FIG. 4B is an enlarged view of portion “A” in FIG. 3, FIGS. 5A and 5B show operation examples of the check valve of the present invention, FIG. 6 shows another embodiment of the LED cooling device of the present invention, FIG. 7 shows still another embodiment of the LED cooling device of the present invention, and FIGS. 8A and 8B show usage examples of the LED cooling device of the present invention.

As shown in FIGS. 2 and 3, an LED cooling device 1 of the present invention includes an LED lamp 10 in which an LED 12 which emits light is provided on one surface of a substrate 11 and heat exchanging means 14 which absorbs heat and radiates the absorbed heat on the other surface, a pumping member 20 that includes a supply hole 22 which is formed at a lower end of an outer periphery on one surface to supply air to one surface of the heat exchanging means 14 of the LED lamp 10, an introduction hole 24 which is formed at the center of an upper end in order to allow air to be introduced, and a check valve 25 which is formed at the introduction hole 24 to control the introduction of the air, an operational lobe 30 that is provided at the center of a lower end of the pumping member 20 at a predetermined length, and a transfer unit 40 that moves the operation lobe 30 up and down to expand and contract the pumping member 20.

The heat exchanging means 14 of the LED lamp 10 is an air-cooling or water-cooling heat radiation plate which is generally used.

As shown in FIGS. 4A and 4B, the check valve 25 has a structure in which a contact plate 25-4 that is moved up and down is provided inside a pipe 25-2 provided with a penetrating hole 25-1 in a lateral surface.

The check valve 25 is provided inside the pumping member 20 to correspond to the introduction hole 24, and controls the introduction hole 24 of the pumping member 20 by the expansion and pressure of the inside of the pumping member 20 when the operational lobe 30 connected to the transfer device 40 is moved up and down.

That is, as shown in FIG. 5A, when the operational lobe 30 connected to the transfer device 40 is moved downward, the pumping member 20 is pulled, and an expansion pressure is generated in the inside of the pumping member 20. In this case, the contact plate 25-4 provided in the pipe 25-2 is moved downward by the expansion pressure, and thus, the introduction hole 24 of the pumping member 20 is opened to allow the air to be introduced. As shown in FIG. 5B, if the operational lobe 30 connected to the transfer device 40 is moved upward, the pumping member 20 is pressurized, and thus, the contact plate 25-4 provided in the pipe 25-2 is moved upward by the internal pressure. As a result, the introduction hole 24 of the pumping member 20 is closed, and thus, the air is prevented from being discharged.

As stated above, the check valve 25 may have various structures such as a structure in which the check valve is opened or closed by the pressure of the air.

It is preferable that the transfer device 40 is realized as a solenoid device using magnetic force such that the operation lobe 30 can be moved up and down.

As mentioned above, it is preferable that a corrugated pipe 28 having a predetermined length is formed at the center of the lower end of the pumping member 20 such that the internal pressure and expansion of the pumping member 20 are more easily performed by the operational lobe 30 and the operational lobe 30 is connected to one surface of the corrugated pipe 28.

That is, the corrugated pipe 28 of the pumping member 20 connected to the operation lobe 30 is formed, and thus, a space to which the air can be introduced becomes large, and the contraction and expansion are easily performed by the corrugated pipe 28.

As mentioned above, it is preferable that the amount of heat which is generated in the heat exchanging means 14 of the LED lamp 10 and is introduced to the pumping member 20 is minimized when the pumping member 20 is expanded by operating the operational lobe 30 connected to the transfer device 40 and the inner diameter of the supply hole 22 of the pumping member 20 is less than the inner diameter of the introduction hole 24 of the pumping member 20 such that the heat can be easily supplied to the heat exchanging means 14 of the LED lamp 10.

As described above, it is preferable that the supply hole 22 of the pumping member 20 is formed so as to correspond to the heat pipe device 14 of the LED lamp 10, and as the supply hole, a plurality of supply holes may be formed so as to be separated at predetermined distances.

As stated above, as shown in FIG. 6, a second supply hole 34 connected to the pumping member 20 is formed in the operation lobe 30 such that the air can be further supplied to the heat pipe device 14 of the LED lamp 10, and the air is supplied to the heat exchanging means 14 of the LED lamp 10. Accordingly, air circulation to the heat exchanging means 14 is further increased, and thus, a cooling effect is increased.

Similarly to the supply hole 22 of the pumping member 20, it is preferable that the inner diameter of the second supply hole 34 is less than the inner diameter of the introduction hole 24 of the pumping member 20.

That is, as stated above, the supply hole 22 and the second supply hole 34 serve as nozzles, and easily circulate heat to the heat exchanging means 14 of the LED lamp 10. Accordingly, cooling efficiency is increased.

As mentioned above, as shown in FIG. 7, the pumping members 20 are provided at both ends of the operation lobe 30 such that the air can be further supplied to the heat exchanging means 14 of the LED lamp 10.

That is, the pumping members 20 are provided at both ends of the operational lobe 30 provided at one transfer device 40, and the air is supplied to the heat exchanging means 14 of the LED lamp 10 in both directions by the expansion and contraction of the pumping member 20. Thus, the cooling effect of the heat exchanging means 14 can be further increased.

As the usage example of the LED cooling device 1 of the present invention, as shown in FIGS. 8A and 8B, the LED cooling device 1 of the present invention includes an LED lamp 10 in which an LED 12 which emits light is provided on one surface of a substrate 11 and heat exchanging means 14 which absorbs heat and radiates the absorbed heat on the other surface, a pumping member 20 that includes a supply hole 22 which is formed at a lower end of an outer periphery on one surface to supply air to one surface of the heat exchanging means 14 of the LED lamp 10, an introduction hole 24 which is formed at the center of an upper end in order to allow air to be introduced, and a check valve 25 which is formed at the introduction hole 24 to control the introduction of the air, an operational lobe 30 that is provided at the center of a lower end of the pumping member 20 with a predetermined length, and a transfer unit 40 that moves the operation lobe 30 up and down to expand and contract the pumping member 20.

As described above, in the LED cooling device 1, if the operational lobe 30 connected to the transfer device 40 is operated downward, the check valve 25 of the pumping member 20 opens the introduction hole 24 of the pumping member 20 by the expansion pressure generated inside the pumping member 20, and thus, the air is introduced to the inside of the pumping member 20 through the introduction hole 24 of the pumping member 20 and the supply hole 22 of the pumping member 20. If the operational lobe 30 connected to the transfer device 40 is operated upward, the check valve 25 of the pumping member 20 closes the introduction hole 24 of the pumping member 20 by the contraction air generated inside the pumping member 20, and thus, the air is supplied to the heat exchanging means 14 of the LED lamp 10 through the supply hole 22 of the pumping member 20 to cool the heat exchanging means 14.

As described above, according to the LED cooling device of the present invention, the cooling device that supplies the air to the heat exchanging means that absorbs the heat of the LED and radiates the heat is provided, and thus, the air is smoothly circulated to the heat exchanging means that absorbs the heat and the radiates the heat. Accordingly, it is possible to increase the cooling efficiency.

Description of Reference Numerals

| 1: LED cooling device | |
|---|---|
| 10: LED lamp | |
| 14: heat exchanging means | |
| 20: pumping member | 22: supply hole |
| 24: introduction hole | 25: check valve |
| 25-2: pipe | 25-4: contact plate |
| 28: corrugated pipe | |
| 30: operational lobe | 34: second supply hole |

40: transfer device

1. A LED cooling device comprising:
an LED lamp in which an LED which emits light is provided on one surface of a substrate and a heat exchanging means that absorbs heat and radiates the absorbed heat is provided on the other surface of the substrate;
a pumping member that includes a supply hole which is formed at a lower end of an outer periphery on one surface to supply air to one surface of the heat exchanging means of the LED lamp, an introduction hole which is formed at the center of an upper end in order to allow air to be introduced, and a check valve which is formed at the introduction hole to control the introduction of the air;
an operational lobe that is provided at the center of a lower end of the pumping member at a predetermined length; and
a transfer unit that moves the operation lobe up and down to expand and contract the pumping member.

2. The LED cooling device according to claim 1, wherein a corrugated pipe is formed at a center of a lower end of the pumping member with a predetermined length, and the operational lobe is connected to one surface of the corrugated pipe.

3. The LED cooling device according claim 1, wherein a second supply hole connected to the pumping means is formed in the operational lobe.

4. The LED cooling device according to claim 1, wherein pumping members are provided at both ends of the operational lobe.
